(19) United States
(12) Patent Application Publication
(10) Pub. No.: US 2016/0330804 A1
(43) Pub. Date: Nov. 10, 2016

(54) LIGHT-EMITTING DIODE LIGHTING DEVICE FOR BEING DIRECTLY ELECTRICALLY CONNECTED TO ALTERNATING CURRENT POWER SUPPLY

(71) Applicant: Edison Opto Corporation, New Taipei City (TW)

(72) Inventor: Kuo-Feng TSENG, New Taipei City (TW)

(21) Appl. No.: 15/076,642

(22) Filed: Mar. 21, 2016

(30) Foreign Application Priority Data
May 5, 2015 (TW) 104114304

(51) Int. Cl. H05B 33/08

(52) U.S. Cl. CPC H05B 33/0809; H05B 33/0845

(57) ABSTRACT

A light-emitting diode (LED) lighting device for being directly electrically connected to an alternating current power supply includes a substrate, a first LED, a first fluorescent layer, a second LED, a second fluorescent layer, and a control module. Top surface of the substrate includes a first region, a second region, and a third region. The first LED is disposed on the first region. The first fluorescent layer covers the first LED. The second LED is disposed on the second region. The second fluorescent layer covers the second LED. The control module is disposed on the third region and electrically connected to an external power supply, the first LED, and the second LED. The bridge rectifying unit of the control module transforms external alternating current into direct current. The current-limiting unit of the control module controls whether the first LED and the second LED are turned on.

### RELATED APPLICATIONS

This application claims priority to Taiwanese Application Serial Number 104114304, filed May 5, 2015, which are herein incorporated by reference.

### BACKGROUND

1. Technical Field

The present disclosure relates to a light-emitting diode (LED) lighting device.

2. Description of Related Art

Light-emitting diodes (LEDs) have the advantages of high brightness, fast response, small size, low pollution, high reliability, suitability for mass production, along with many more advantages. There continue to be more and more applications for LEDs in lighting or consumer electronics products. Currently, LEDs are widely applied as light sources of large-scale billboards, traffic lights, cell phones, scanners, fax machines, and lighting devices, along with many other applications. From the above applications, it can be known that the luminous efficiency and the brightness of LEDs get more and more attention, so that the research and development of high-brightness LEDs become an important topic in solid-state lighting applications.

LEDs have replaced fluorescent and incandescent lamps in some applications, such as a light source for a scanner which demands a high-speed response, a light source for a projection device, a backlight or a front light of a liquid crystal display, a light source for a car dashboard, a light source of a traffic light, light sources for general lighting devices, with many more useful applications. Compared to conventional lamps, LEDs have significant advantages such as a smaller size, a longer operation life, a low driving voltage/current, high structural strength, no mercury pollution, and high luminous efficiency (energy saving), as well as many other advantages.

To further improve various characteristics of a lighting device, persons in the industry all endeavor to search for practical solutions. The application of LEDs in lighting devices is one of many important research topics, and is also a target that needs to be improved in many related fields.

### SUMMARY

This disclosure provides a light-emitting diode (LED) lighting device for being directly electrically connected to an alternating current power supply. The average color temperature of the light emitted by the LED lighting device can be adjusted according to different needs.

In one aspect of the disclosure, an LED lighting device for being directly electrically connected to an alternating current power supply is provided. The LED lighting device includes a substrate, at least one first LED, a first fluorescent layer, at least one second LED, a second fluorescent layer, and a control module. The substrate has a top surface, and the top surface includes a first region, a second region, and a third region. The first LED is disposed on the first region. The first fluorescent layer is disposed on the first region and covers the first LED. The second LED is disposed on the second region. The second fluorescent layer is disposed on the second region and covers the second LED. The control module is disposed on the third region and configured to be electrically connected to an external power supply, the first LED, and the second LED. The control module includes at least one bridge rectifying unit and at least one current-limiting unit. The bridge rectifying unit is configured to transform an external alternating current into a direct current, and the current-limiting unit is configured to control whether the first LED and/or the second LED are to be turned on.

The user can adjust the average color temperature of the light emitted by the LED light device according to the actual needs by adjusting the magnitude of the current passing the current-limiting unit to determine whether the LEDs are turned on because the color temperatures of the light emitted from the fluorescent layers are different. At the same time, because the LED lighting device 100 can be directly electrically connected to an alternating current power supply, the LED lighting device can be directly electrically connected to the household power supply. Therefore, no other power conversion device is needed, so it becomes more easy and convenient to use the LED lighting device.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic top view of a light-emitting diode (LED) lighting device for being directly electrically connected to an alternating current power supply according to one embodiment of this invention;

FIG. 2 is a schematic cross-sectional view viewed along line 2-2 of FIG. 1;

FIG. 3 is a schematic block diagram of the LED lighting device of FIG. 1;

FIG. 4 is a schematic top view of the LED lighting device for being directly electrically connected to an alternating current power supply according to one embodiment of this invention;

FIG. 5 is a schematic top view of the LED lighting device for being directly electrically connected to an alternating current power supply according to one embodiment of this invention;

FIG. 6 is a schematic top view of the LED lighting device for being directly electrically connected to an alternating current power supply according to one embodiment of this invention; and

FIG. 7 is a schematic top view of the LED lighting device for being directly electrically connected to an alternating current power supply according to one embodiment of this invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

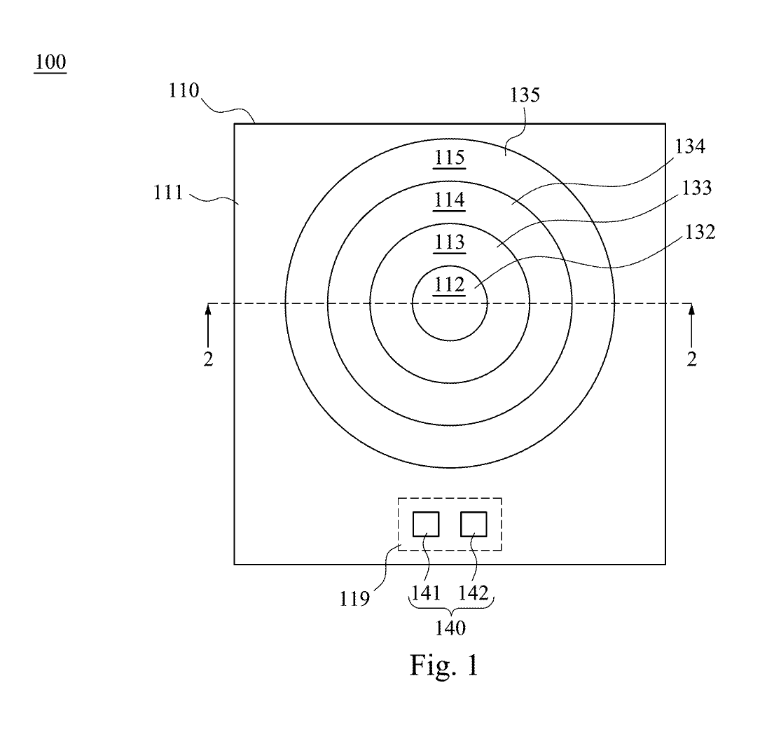

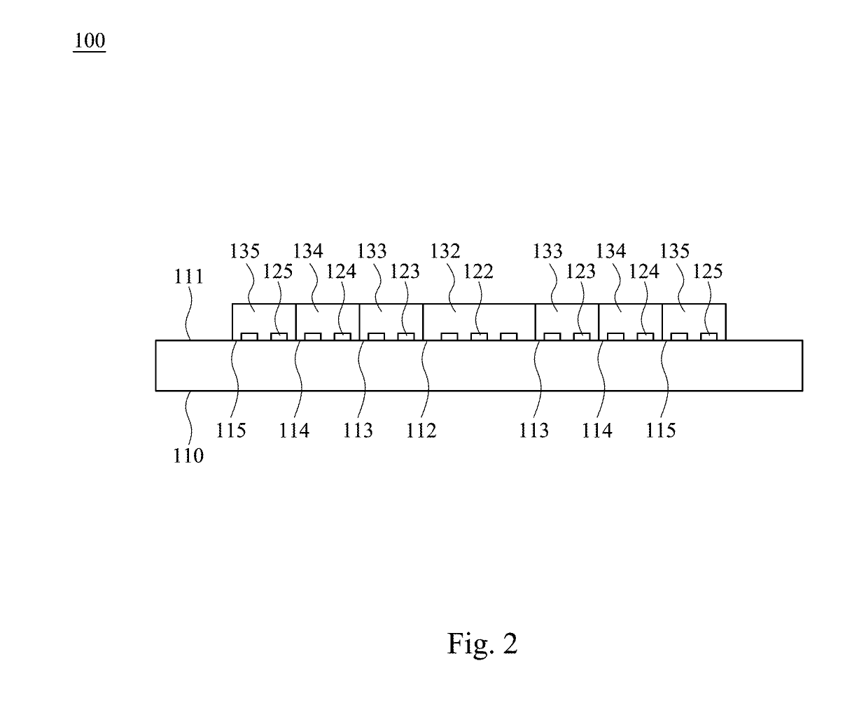

FIG. 1 is a schematic top view of a light-emitting diode (LED) lighting device 100 for being directly electrically connected to an alternating current power supply according to one embodiment of this invention. FIG. 2 is a schematic cross-sectional view viewed along line 2-2 of FIG. 1. An LED lighting device 100 is provided. The average color temperature of the light emitted from the LED lighting device 100 can be adjusted according to different needs.

As shown in FIG. 1 and FIG. 2, the LED lighting device 100 includes a substrate 110, at least one LED 122, at least one LED 123, at least one LED 124, at least one LED 125, fluorescent layers 132, 133, 134 and 135, and a control module 140. The substrate 110 has a top surface 111, and the top surface 111 includes regions 112, 113, 114, 115, and 119. The LED 122 is disposed on the region 112. The fluorescent layer 132 is disposed on the region 112 and covers the LED 122. The LED 123 is disposed on the region 113. The fluorescent layer 133 is disposed on the region 113 and covers the LED 123. The LED 124 is disposed on the region 114. The fluorescent layer 134 is disposed on the region 114 and covers the LED 124. The LED 125 is disposed on the region 115. The fluorescent layer 135 is disposed on the region 115 and covers the LED 125. The control module 140 is disposed on the region 119 and electrically connected to an external power supply, the LEDs 122, 123, 124, and 125. The control module 140 includes at least one bridge rectifying unit 141 and at least one current-limiting unit 142. The bridge rectifying unit 141 transforms an external alternating current into a direct current, and the current-limiting unit 142 controls whether the LEDs 122, 123, 124, and 125 are turned on. For example, the current-limiting unit 142 controls the LEDs 122, 123, 124, and 125 to be sequentially turned on with the increase of the current passing the current-limiting unit 142. Embodiments of this disclosure are not limited thereto. The person having ordinary skill in the art can make proper modifications to how the current-limiting unit 142 controls the LEDs 122, 123, 124, and 125 depending on the actual application. For example, in some embodiments, the LEDs 122 and 124 are turned on first, while in some other embodiments, the LEDs 123 and 125 are turned on first.

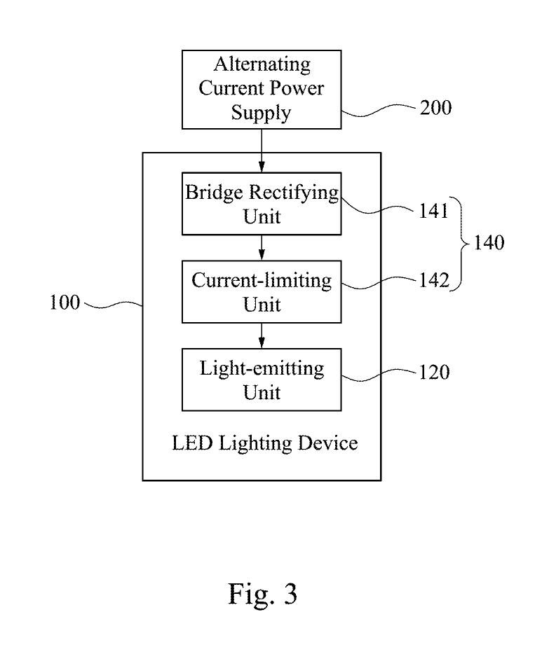

FIG. 3 is a schematic block diagram of the LED lighting device 100 of FIG. 1. As shown in FIG. 3, the bridge rectifying unit 141 is electrically connected to an external alternating current power supply 200 and the current-limiting unit 142. After the bridge rectifying unit 141 transforms an external alternating current into a direct current, the current-limiting unit 142 receives the direct current from the bridge rectifying unit 141, and the current-limiting unit 142 controls whether the LEDs 122, 123, 124, and 125 of the light-emitting unit 120 are turned on according to the magnitude of the direct current.

For example, as shown in FIG. 1 and FIG. 2, when the current passing the bridge current-limiting unit 142 is 2 amperes, only the LED 122 is turned on. Then, when the current passing the current-limiting unit 142 is gradually increased from 2 amperes to 3 amperes, the LED 123 is also turned on, i.e., the LEDs 122 and 123 are turned on. Then, when the current passing the current-limiting unit 142 is gradually increased from 3 amperes to 4 amperes, the LED 124 is also turned on, i.e., the LEDs 122, 123, and 124 are turned on. Finally, when the current passing the current-limiting unit 142 is gradually increased from 4 amperes to 5 amperes, the LED 125 is also turned on, i.e., the LEDs 122, 123, 124, and 125 are all turned on.

The aforementioned description is the circuit configuration of this embodiment, but embodiments of this disclosure are not limited thereto. In other embodiments, the circuit configuration of the control module 140 may not be the same as that of this embodiment. The key point is that the control module 140 should be able to transform an external alternating current into a direct current and control the LEDs 122, 123, 124, and 125, such that the LEDs 122, 123, 124, and 125 are sequentially turned on with the increase of the current passing the control module 140.

Specifically, the light emitted from the fluorescent layer 132 is a light mixed with the light emitted by the LED 122 and the light emitted by the LED 122 and then converted by the fluorescent layer 132 when passing the fluorescent layer 132. The light emitted from the fluorescent layer 133 is a light mixed with the light emitted by the LED 123 and the light emitted by the LED 123 and then converted by the fluorescent layer 133 when passing the fluorescent layer 133. The light emitted from the fluorescent layer 134 is a light mixed with the light emitted by the LED 124 and the light emitted by the LED 124 and then converted by the fluorescent layer 134 when passing the fluorescent layer 134. The light emitted from the fluorescent layer 135 is a light mixed with the light emitted by the LED 125 and the light emitted by the LED 125 and then converted by the fluorescent layer 135 when passing the fluorescent layer 135.

In this embodiment, the color temperature of the light emitted from the fluorescent layer 132 is the same as the color temperature of the light emitted from the fluorescent layer 133. The color temperature of the light emitted from the fluorescent layer 134 is the same as the color temperature of the light emitted from the fluorescent layer 135. The color temperature of the light emitted from the fluorescent layers 132 and 133 is different from the color temperature of the light emitted from the fluorescent layers 134 and 135. Embodiments of this disclosure are not limited thereto. In other embodiments, the color temperatures of the light emitted from the fluorescent layers 132, 133, 134, and 135 may be the same or different, and the key point is that the color temperature of the light emitted from at least one of the fluorescent layers should be different from the color temperature of the light emitted from the other of the fluorescent layers.

Because the color temperature of the light emitted from the fluorescent layers 132 and 133 is different from the color temperature of the light emitted from the fluorescent later 134 and 135, the light with different color temperatures will be mixed when the LEDs 122, 123, and 124 are turned on or the LEDs, 122, 123, 124, and 125 are all turned on, such that the average color temperature of the light emitted by the LED lighting device 100 when the LED 122 is turned on or when the LEDs 122 and 123 are turned on is different from the average color temperature of the light emitted by the LED lighting device 100 when the LEDs 122, 123, and 124 are turned on or when the LEDs 122, 123, 124, and 125 are all turned on. Therefore, by adjusting the magnitude of the external alternating current, after the alternating current is transformed into the direct current, the current-limiting unit 142 determines whether the LEDs are turned on according to the magnitude of the direct current, such that the average color temperature of the light emitted by the LED lighting device 100 can be adjusted according to different needs.

At the same time, because the LED lighting device 100 can be directly electrically connected to an alternating current power supply, the LED lighting device 100 can be directly electrically connected to the household power supply (which provides the 60 Hz alternating current). Therefore, no other power conversion device is needed, so it becomes more easy and convenient to use the LED lighting device 100.

Specifically, the color temperature of the light emitted from the fluorescent layers 132 and 133 is in a range from about 1000 K to about 4000 K, and the color temperature of the light emitted from the fluorescent layers 134 and 135 is in a range from about 3000 K to 10000 K. More specifically, the color temperature of the light emitted from the fluorescent layers 132 and 133 may be about 2200 K, and the color temperature of the light emitted from the fluorescent layers 134 and 135 may be about 5700 K. Therefore, when the LED 122 is turned or when the LEDs 122 and 123 are turned on, the average color temperature of the light emitted by the LED lighting device 100 is about 2200 K. When the LEDs 122, 123, and 124 are turned on, the average color temperature of the light emitted by the LED lighting device 100 is in a range from about 3500 K to about 4500 K. When the LEDs 122, 123, 124, and 125 are all turned one, the average color temperature of the light emitted by the LED lighting device 100 is in a range from about 4000 K to about 5000 K. Embodiments of this disclosure are not limited thereto. The person having ordinary skill in the art can make proper modifications to the color temperature of the light emitted from the fluorescent layers 132, 133, 134, and 135 or the mixed light thereof depending on the actual application.

The fluorescent layers 132, 133, 134, and 135 may be molding compounds. Embodiments of this disclosure are not limited thereto. In other embodiments, the fluorescent layers 132, 133, 134, and 135 may be patches attached to the LEDs 122, 123, 124, and 125.

Specifically, the shape of the region 112 is circular, and the shape of the region 113 is a circular ring surrounding the region 112. The shape of the region 114 is a circular ring surrounding the region 113, and the shape of the region 115 is a circular ring surrounding the region 114.

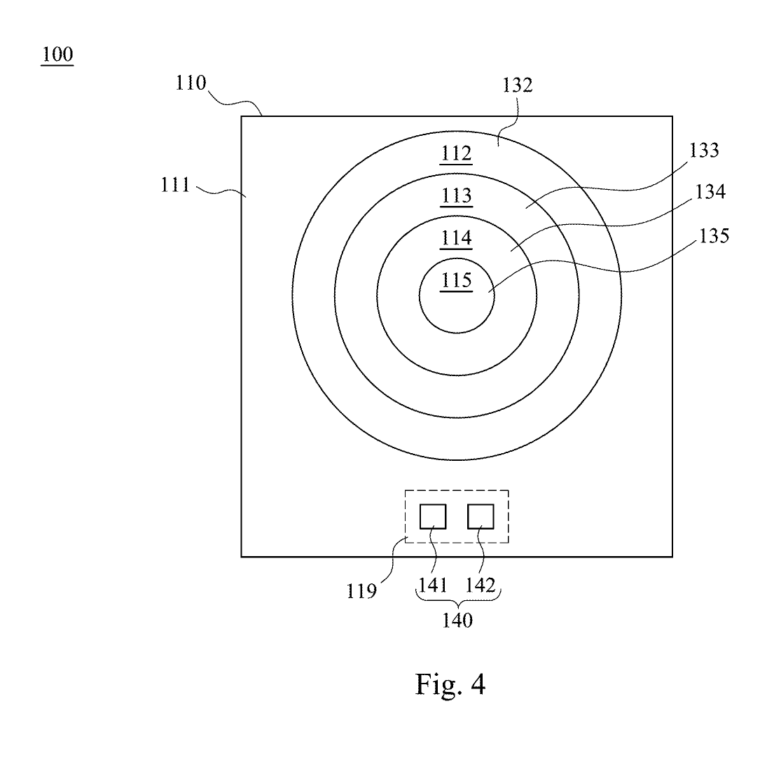

FIG. 4 is a schematic top view of the LED lighting device 100 according to one embodiment of this invention. The LED lighting device 100 of this embodiment is similar to the LED lighting device 100 of the aforementioned embodiment, and the differences are described below.

As shown in FIG. 4, the shape of the region 115 is circular, and the shape of the region 114 is a circular ring surrounding the region 115. The shape of the region 113 is a circular ring surrounding the region 114, and the shape of the region 112 is a circular ring surrounding the region 113.

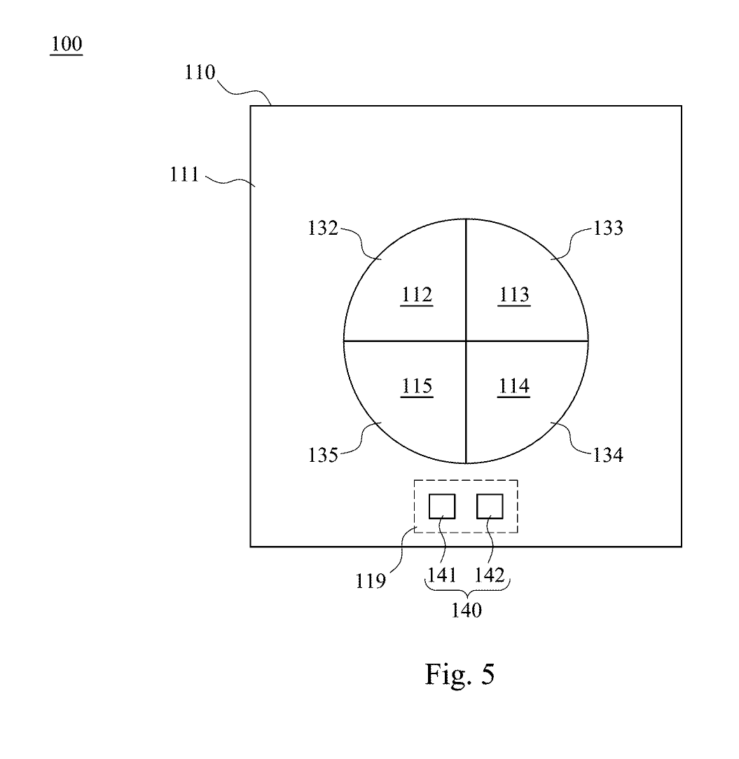

FIG. 5 is a schematic top view of the LED lighting device 100 according to one embodiment of this invention. The LED lighting device 100 of this embodiment is similar to the LED lighting device 100 of the aforementioned embodiments, and the differences are described below.

As shown in FIG. 5, the shapes of the regions 112, 113, 114, and 115 are fan-shaped, and the regions 112, 113, 114, and 115 form a circle. The region 112 is disposed on the upper left side of the circle. The region 113 is disposed on the upper right side of the circle. The region 114 is disposed on the lower right side of the circle. The region 115 is disposed on the lower left side of the circle.

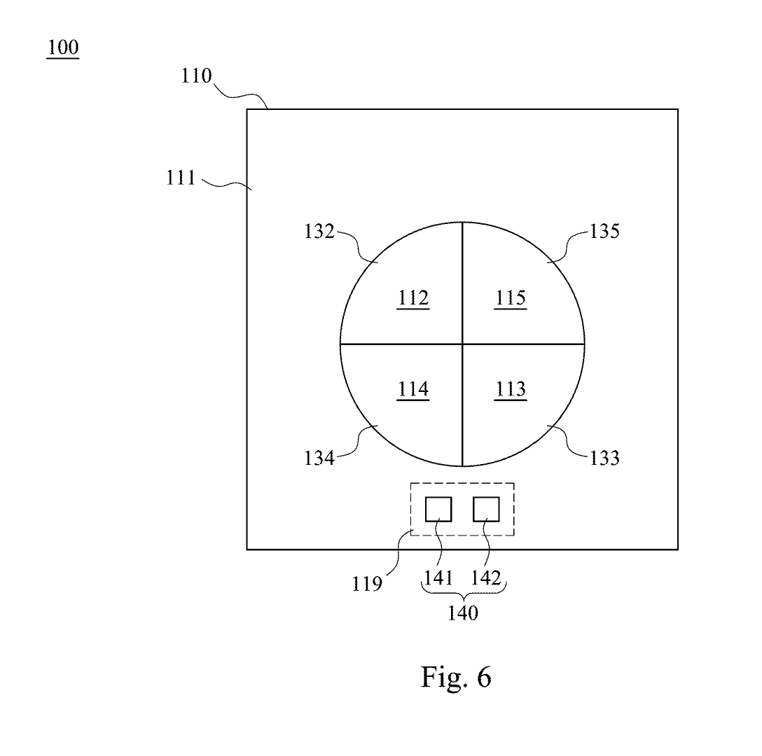

FIG. 6 is a schematic top view of the LED lighting device according to one embodiment of this invention. The LED lighting device 100 of this embodiment is similar to the LED lighting device 100 of FIG. 5, and the differences are described below.

As shown in FIG. 6, the region 112 is disposed on the upper left side of the circle. The region 113 is disposed on the lower right side of the circle. The region 114 is disposed on the lower left side of the circle. The region 115 is disposed on the upper right side of the circle.

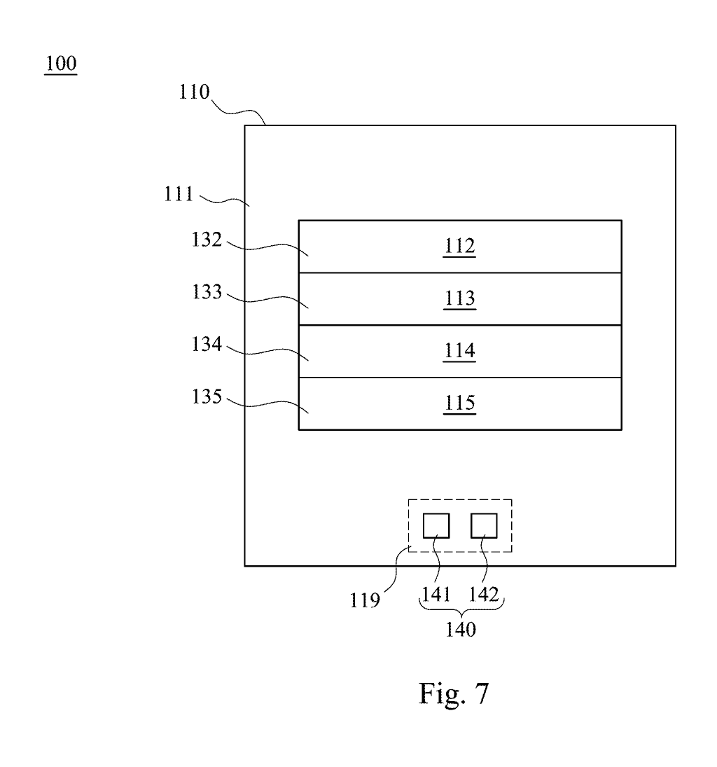

FIG. 7 is a schematic top view of the LED lighting device 100 according to one embodiment of this invention. The LED lighting device 100 of this embodiment is similar to the LED lighting device 100 of the aforementioned embodiments, and the differences are described below.

As shown in FIG. 7, the shapes of the regions 112, 113, 114, and 115 are strip-shaped, and the regions are adjacent to each other and form a rectangle. The region 112 is disposed on the uppermost part of the rectangle. The region 113 is disposed adjacent to and below the region 112. The region 114 is disposed adjacent to and below the region 113. The region 115 is disposed adjacent to and below the region 114.

In another embodiment, The LED lighting device 100 is similar to the LED lighting device 100 of FIG. 7, and the differences are described below. The region 112 is disposed on the uppermost part of the rectangle. The region 114 is disposed adjacent to and below the region 112. The region 113 is disposed adjacent to and below the region 114. The region 115 is disposed adjacent to and below the region 113.

As shown in FIG. 1, FIG. 4 to FIG. 7, the regions 112, 113, 114, and 115 are not limited to specific shapes, and the relative positions of the regions 112, 113, 114, and 115 are not limited as well. The key point is that the light emitted from the fluorescent layers 132, 133, 134, and 135 should be able to be properly mixed.

Because the color temperatures of the light emitted from the fluorescent layers 132, 133, 134, and 135 are different, the user can adjust the average color temperature of the light emitted by the LED light device 100 according to the actual needs by adjusting the magnitude of the current passing the current-limiting unit 142 to determine whether the LEDs 122, 123, 124, and 125 are turned on. At the same time, because the LED lighting device 100 can be directly electrically connected to an alternating current power supply, the LED lighting device 100 can be directly electrically connected to the household power supply. Therefore, no other power conversion device is needed, so it becomes more easy and convenient to use the LED lighting device 100.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A light-emitting diode (LED) lighting device for being directly electrically connected to an alternating current power supply, comprising:
a substrate having a top surface, wherein the top surface comprises a first region, a second region, and a third region;
at least one first LED disposed on the first region;
a first fluorescent layer disposed on the first region and covering the first LED;
at least one second LED disposed on the second region;
a second fluorescent layer disposed on the second region and covering the second LED; and
a control module disposed on the third region and configured to be electrically connected to an external power supply, the first LED, and the second LED, wherein the control module comprises at least one bridge rectifying unit and at least one current-limiting unit, the bridge rectifying unit is configured to transform an external alternating current into a direct current, and the current-limiting unit is configured to control whether the first LED and the second LED are turned on.

2. The LED lighting device of claim 1, wherein a color temperature of a light emitted from the first fluorescent layer is different from a color temperature of a light emitted from the second fluorescent layer.

3. The LED lighting device of claim 1, wherein a color temperature of a light emitted from the first fluorescent layer is in a range from about 1000 K to about 4000 K, and a color temperature of a light emitted from the second fluorescent layer is in a range from about 3000 K to 10000 K.

4. The LED lighting device of claim 1, wherein the top surface further comprises a fourth region; and
the LED lighting device, further comprising:
at least one third LED disposed on the fourth region, wherein the control module is configured to be electrically connected to the external power supply, the first LED, the second LED, and the third LED, and the current-limiting unit is configured to control whether the first LED, the second LED, and the third LED are turned on; and
a third fluorescent layer disposed on the fourth region and covering the third LED, wherein a color temperature of a light emitted from the first fluorescent layer is the same as a color temperature of a light emitted from the second fluorescent layer, and the color temperature of the light emitted from the first fluorescent layer is different from a color temperature of a light emitted from the third fluorescent layer.

5. The LED lighting device of claim 4, wherein the color temperature of the light emitted from the first fluorescent layer is in a range from about 1000 K to about 4000 K, and the color temperature of the light emitted from the third fluorescent layer is in a range from about 3000 K to 10000 K.

6. The LED lighting device of claim 4, wherein the top surface further comprises a fifth region; and
the LED lighting device, further comprising:
at least one fourth LED disposed on the fifth region, wherein the control module is configured to be electrically connected to the external power supply, the first LED, the second LED, the third LED and the fourth LED, and the current-limiting unit is configured to control whether the first LED, the second LED, the third LED, and the fourth LED are turned on; and
a fourth fluorescent layer disposed on the fifth region and covering the fourth LED, wherein the color temperature of the light emitted from the third fluorescent layer is the same as a color temperature of a light emitted from the fourth fluorescent layer.

7. The LED lighting device of claim 6, wherein the color temperature of the light emitted from the first fluorescent layer is in a range from about 1000 K to about 4000 K, and the color temperature of the light emitted from the third fluorescent layer is in a range from about 3000 K to 10000 K.

8. The LED lighting device of claim 1, wherein a shape of the first region is circular, and a shape of the second region is a circular ring surrounding the first region.

9. The LED lighting device of claim 1, wherein shapes of the first region and the second region are strip-shaped, and the first region and the second region are adjacent to each other.

10. The LED lighting device of claim 1, wherein shapes of the first region and the second region are fan-shaped.
